(19) United States
(12) Patent Application Publication
(10) Pub. No.: US 2012/0176730 A1
(43) Pub. Date: Jul. 12, 2012

(54) ELECTRIC STORAGE DEVICE

(75) Inventors: Daigo TAKEMURA, Tokyo (JP); Tetsuya Yagi, Tokyo (JP); Tatsunori Okada, Tokyo (JP); Shuichi Matsumoto, Tokyo (JP); Kenro Mitsuda, Tokyo (JP)

(73) Assignee: MITSUBISHI ELECTRIC CORPORATION, Tokyo (JP)

(21) Appl. No.: 13/344,103

(22) Filed: Jan. 5, 2012

(30) Foreign Application Priority Data
Jan. 6, 2011 (JP) 2011-001167
Nov. 18, 2011 (JP) 2011-252270

(51) Int. Cl. H01G 9/12; H01G 9/10

(52) U.S. Cl. 361/518

(57) ABSTRACT

An electric storage device includes an electric storage device body impregnated with an electrolyte solution, a sheath for hermetically sealing the electric storage device body, and a pressure regulator provided at the sheath. The pressure regulator includes a plurality of gas release mechanism portions. Further, the pressure regulator allows release of gases from an inside space of the sheath in which the electric storage device body exists to an outside space by causing the gases from the inside space to pass through the gas release mechanism portions in succession, and blocks entry of gases from the outside space to the inside space by the respective gas release mechanism portions. A buffer space is formed between the gas release mechanism portions by being partitioned by the gas release mechanism portions.

### BACKGROUND OF THE INVENTION

1. Field of the Invention

The present invention relates to an electric storage device in which a sheath for hermetically sealing an electric storage device body impregnated with an electrolyte solution is provided with a pressure regulator.

2. Description of the Related Art

An electric double-layer capacitor is an electric storage device in which an electric storage device element including a positive electrode, a negative electrode, and a separator sandwiched between the positive electrode and the negative electrode is housed in a sheath in a state of being impregnated with an electrolyte solution. An electric double-layer capacitor is also often referred to as an electric double-layer condenser, a supercapacitor, an ultracapacitor, or an electrochemical capacitor, and is also often simply referred to as a capacitor. In a lithium ion capacitor which is a hybrid of an electric double-layer capacitor and a lithium ion secondary battery, it is often the case that an electrode material of an electric double-layer capacitor such as activated carbon is used for the positive electrode while an electrode material of a lithium ion secondary battery which may occlude and release lithium ions is used for the negative electrode, but there is also a lithium ion capacitor in which an electrode material of a lithium ion battery is used for a part of the positive electrode. Further, there is also a hybrid capacitor in which, by using a carbon material for the positive electrode, both an electric double-layer capacity on a surface of the carbon material and a capacity by occlusion/release of positive ions in/to the inside of the carbon are utilized.

In an electric storage device such as an electric double-layer capacitor, a lithium ion capacitor, or a hybrid capacitor described above, an electrolyte solution is used, and thus, by hermetically sealing an electric storage device element with a sheath material such as an aluminum laminate sheet having the function as a gas barrier, the electrolyte solution is prevented from leaking to the outside and gases such as water and oxygen are prevented from entering the inside of the sheath material from the outside. On the other hand, in an electric storage device described above, an electrode material having a large specific surface area is used, and thus, the reactive area is large and, when the electric storage device is used for a long term, due to, for example, decomposition of the electrolyte solution and decomposition of impurities adsorbed to the electrode material, gases such as hydrogen, carbon dioxide, carbon monoxide, methane, and ethylene are evolved. Therefore, in an electric storage device described above, the evolution of gases in the sheath material produces problems such as deformation of the sheath material and pressure increase in the sheath material. Further, even when evolution of gases is not a problem under a normal usage environment, if a large current is repeatedly charged and discharged, heat may be generated due to internal resistance of the electric storage device to raise the temperature of the electric storage device. Further, use of the electric storage device under a high voltage environment accelerates evolution of gases in the sheath material.

Conventionally, in order to suppress deformation of the sheath material and pressure increase in the sheath material, an electric storage device has been proposed in which the sheath material is provided with a vent hole and a gas release valve is attached from the inside of the sheath material so as to cover the vent hole. The gas release valve releases a gas from the inside of the sheath material via the vent hole to the outside and prevents entry of oxygen, moisture, and the like from the outside to the inside of the sheath material (see, for example, Japanese Patent Application Laid-open Nos. 2004-128199 and 2008-153282).

Further, conventionally, an electric storage device has been proposed in which, by providing an opening in the sheath material and fitting into the opening a degassing vent which may release gases in the sheath material to the outside, abnormal increase in the internal pressure of the sheath material is prevented (see, for example, Japanese Patent Application Laid-open No. 2003-297700).

However, in the electric storage devices disclosed in Japanese Patent Application Laid-open Nos. 2004-128199, 2008-153282, and 2003-297700, the whole of the gas release valve or the degassing vent attached to the sheath material is in contact with the outside air, and thus, under a high humidity environment, condensed water is more liable to be accumulated in the gas release valve or the degassing vent. This may deteriorate the function of preventing entry of oxygen, moisture, and the like to the inside of the sheath material with regard to the gas release valve or the degassing vent. Further, when a metallic component is used in the gas release valve or the degassing vent, the function of the gas release valve or the degassing vent may be deteriorated by corrosion of the metallic component. Even when a component formed of rubber or the like is used, the function may be deteriorated by embrittlement or the like. Further, gases which are evolved in the sheath material may include a vaporized component of the electrolyte solution. The components of the gases differ between the inside and the outside of the electric storage device, and thus, it is necessary to separately select an appropriate material for the hermetic seal with regard to the inside and the outside of the sheath material.

### SUMMARY OF THE INVENTION

The present invention has been made to solve the above-mentioned problems, and it is an object of the present invention to obtain an electric storage device which may suppress for a long term the deterioration of the function of a pressure regulator therein.

According to the present invention, there is provided an electric storage device, including: an electric storage device body impregnated with an electrolyte solution; a sheath for hermetically sealing the electric storage device body; and a pressure regulator including a first gas release mechanism portion provided inside the sheath and a second gas release mechanism portion provided outside the sheath, the pressure regulator being provided to the sheath, allowing release of gases from an inside space of the sheath in which the electric storage device body exists to an outside space by causing the gases from the inside space to pass through the first gas release mechanism portion and the second gas release mechanism portion in succession, and blocking entry of gases from the outside space to the inside space by the first gas release mechanism portion and the second gas release mechanism portion, in which a buffer space is formed between the first gas release mechanism portion and the second gas release mechanism portion by being partitioned by the first gas release mechanism portion and the second gas release mechanism portion.

In the electric storage device according to the present invention, the first gas release mechanism portion is provided inside the sheath while the second gas release mechanism portion is provided outside the sheath. By causing gases from the inside space to pass through the gas release mechanism portions in succession, release of the gases from the inside space to the outside space is allowed, while entry of gases from the outside space to the inside space is blocked by the respective gas release mechanism portions. A buffer space formed by being partitioned by the gas release mechanism portions is formed between the gas release mechanism portions, and thus, even when the function of any one of the gas release mechanism portions is deteriorated, entry of gases to the inside space may be blocked by the gas release mechanism portion which is not deteriorated, and a pressure regulator suitable for blocking the passing of gases in the inside space and gases or moisture in the outside space may be obtained. Further, at least one of the gas release mechanism portions is disposed away from contact with the outside air, and thus, condensed water is less liable to be generated in the gas release mechanism portion which is disposed away from contact with the outside air, and the function deterioration of that gas release mechanism portion may be suppressed. This enables blocking for a long term of entry of gases from the outside space via the pressure regulator to the inside space, and the function deterioration of the pressure regulator may be suppressed for a long term.

### BRIEF DESCRIPTION OF THE DRAWINGS

In the accompanying drawings:

FIG. 1 is a front view illustrating an electric storage device according to a first embodiment of the present invention;

FIG. 2 is a sectional view taken along the line II-II of FIG. 1;

FIG. 3 is an enlarged sectional view illustrating a pressure regulator of FIG. 2;

FIG. 4 is an exploded perspective view illustrating the pressure regulator of FIG. 3;

FIG. 5 is a sectional view illustrating a pressure regulator of an electric storage device according to a second embodiment of the present invention;

FIG. 6 is an exploded perspective view illustrating the pressure regulator of FIG. 5;

FIG. 7 is a front view illustrating an electric storage device according to a third embodiment of the present invention;

FIG. 8 is a sectional view taken along the line VIII-VIII of FIG. 7;

FIG. 9 is a front view illustrating a heat-sealed portion of two sheets which form a sheath of FIG. 7;

FIG. 10 is an enlarged sectional view illustrating a pressure regulator of FIG. 8;

FIG. 11 is a perspective view illustrating an electric storage device according to a fourth embodiment of the present invention;

FIG. 12 is an exploded perspective view illustrating a pressure regulator in FIG. 11;

FIG. 13 is a sectional view taken along the line XIII-XIII of FIG. 11;

FIG. 14 is a perspective view illustrating an electric storage device according to a fifth embodiment of the present invention;

FIG. 15 is an exploded perspective view illustrating a pressure regulator of FIG. 14;

FIG. 16 is a sectional view taken along the line XVI-XVI of FIG. 14; and

FIG. 17 is a comparative table among Examples 1 to 5 and Comparative Example 1 on the amount of moisture mixed in an electrolyte solution when the electric storage devices in a 0 V discharge state were left under an environment at a temperature of 85° C. and at a relative humidity of 85% RH (experimental environment) for 1,000 hours and when the electric storage devices in a 2 V charge state were left under the same experimental environment for 1,000 hours.

### DETAILED DESCRIPTION OF THE PREFERRED EMBODIMENTS

### First Embodiment

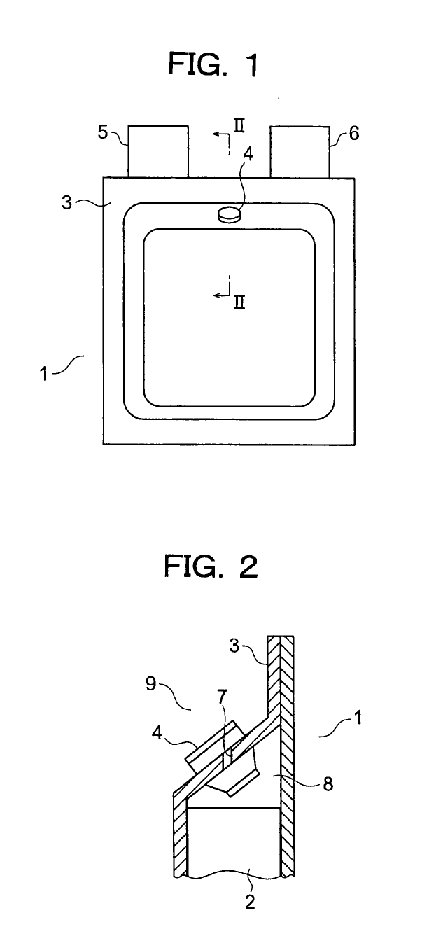

FIG. 1 is a front view illustrating an electric storage device according to a first embodiment of the present invention. FIG. 2 is a sectional view taken along the line II-II of FIG. 1. In the figures, an electric storage device 1 includes a substantially plate-like electric storage device body (electric storage device element) 2 to be charged and discharged, a sheath 3 for encapsulating and hermetically sealing the electric storage device body 2, and a pressure regulator 4 provided in the sheath 3 for regulating the internal pressure of the sheath 3.

A positive electrode current collector terminal 5 and a negative electrode current collector terminal 6 formed of a metal (aluminum, copper, or the like) for electrical connection between the electric storage device body 2 and an external device are connected to the electric storage device body 2. The positive electrode current collector terminal 5 and the negative electrode current collector terminal 6 are routed from an upper end portion of the sheath 3 to the outside of the sheath 3. In this example, each of the positive electrode current collector terminal 5 and the negative electrode current collector terminal 6 is a plate formed of aluminum.

The electric storage device body 2 includes a positive electrode (electrode) to which the positive electrode current collector terminal 5 is connected, a negative electrode (electrode) to which the negative electrode current collector terminal 6 is connected, and a separator sandwiched between the positive electrode and the negative electrode (all not shown). The electric storage device body 2 is formed by laminating, winding, folding, or the like of the combination of the positive electrode, the negative electrode, and the separator.

The positive electrode includes a positive electrode current collector foil and a positive electrode active material layer which is provided between the positive electrode current collector foil and the separator. The positive electrode active material layer is a layer in which a positive electrode active material and a conductive additive are bound by a binder. The negative electrode includes a negative electrode current collector foil and a negative electrode active material layer which is provided between the negative electrode current collector foil and the separator. The negative electrode active material layer is a layer in which a negative electrode active material and a conductive additive are bound by a binder. The separator is a porous film which is electronically insulating.

When the electric storage device 1 is an electric double-layer capacitor, activated carbon after activation treatment having a specific surface area on the order of 500 m²/g to 2,500 m²/g is used as the positive electrode active material and the negative electrode active material, and fine powder of a highly electronically conductive carbon material such as acetylene black is used as the conductive additive. As the binder, for example, a rubber-based binder, polyvinylidene fluoride, or polytetrafluoroethylene (PTFE) is used. Further, as the positive electrode current collector foil and the negative electrode current collector foil, for example, aluminum metal foil is used. As the separator, for example, a porous film formed of cellulose, polyethylene, polypropylene, glass, inorganic powder (alumina, silica, or the like), or the like is solely used or used in combination.

The electric storage device body 2 is impregnated with an electrolyte solution. Charge and discharge of the electric storage device body 2 are made by movement of ions and electrons in the electrolyte solution between the positive electrode and the negative electrode. When charge and discharge of the electric storage device body 2 are made, gases of, for example, hydrogen, carbon dioxide, carbon monoxide, methane, or ethylene are evolved from the electric storage device body 2. The internal pressure of the sheath 3 rises by the evolution of the gases from the electric storage device body 2.

The sheath 3 is an airtight container which blocks passing therethrough of liquid and gas. More specifically, the sheath 3 has the function to be liquid leakage resistant which prevents leakage of the electrolyte solution to the outside, and has the function as a gas barrier which prevents passing therethrough of gases such as moisture or oxygen from the outside. In this example, the sheath 3 is a deformable bag.

As the sheath 3, for example, an aluminum laminate sheet is used. The aluminum laminate sheet used for the sheath 3 is a sheet in which a nylon layer is stacked on one surface of an aluminum metal foil and a polypropylene layer is stacked on the other surface thereof. The surface of the aluminum laminate sheet having the nylon layer stacked thereon is an outer surface of the sheath 3 while the surface of the aluminum laminate sheet having the polypropylene layer stacked thereon is an inner surface of the sheath 3. Further, the sheath 3 is manufactured by heat-sealing rims of two aluminum laminate sheets, one of which is placed on top of the other. The electric storage device body 2 is hermetically sealed within the sheath 3 by heat-sealing the aluminum laminate sheets.

As the layer to be stacked on the outer surface side of the sheath 3 seen from the aluminum metal foil of the aluminum laminate sheet, instead of the polyamide layer such as the nylon layer, a layer of a resin including a polyester resin such as polyethylene terephthalate (PET) or polyethylene naphthalate (PEN) and a polypropylene (PP) resin, or a stacked portion in which a plurality of resin layers which are different from one another are stacked may be used. As the layer to be stacked on the inner surface side of the sheath 3 seen from the aluminum metal foil of the aluminum laminate sheet, instead of the polypropylene layer, a layer of a thermoplastic resin such as polyethylene (PE) or an ethylene-vinyl acetate copolymer resin may be used. Further, an aluminum laminate sheet including as an intermediate layer thereof a hydrogen fluoride protective layer or a moisture trap layer may be used for the sheath 3.

Note that, in this example, the aluminum laminate sheet is used as a member for forming the sheath 3, but the member may be anything insofar as the member prevents leakage of the electrolyte solution and has the function as a gas barrier. For example, the sheath 3 may be formed by a stainless steel metal foil laminate sheet, metal deposition film, or the like. Further, the sheath 3 may be formed of a sole metal such as aluminum or a stainless steel, may be formed of a sole resin such as PP, PE, or PET, and further, may be formed of a member having a composite layer of a metal and a resin.

At an outer edge portion of the sheath 3 from which the positive electrode current collector terminal 5 and the negative electrode current collector terminal 6 are routed to the outside, the positive electrode current collector terminal 5 and the negative electrode current collector terminal 6 are joined by heat-sealing or the like to a resin layer inside the sheath 3, but the strength of the joint between the metal and the resin is low, and thus, a metal fusion resin member which is modified by an acid or the like to improve the strength of the joint thereof with a metal is provided between the positive electrode current collector terminal 5 and the resin layer inside the sheath 3 and between the negative electrode current collector terminal 6 and the resin layer inside the sheath 3, respectively. With regard to the material of the metal fusion resin member, a material which is easily joined to the resin layer inside the sheath 3 is selected. This may improve the strength of the joint between the positive electrode current collector terminal 5 and the sheath 3 and the strength of the joint between the negative electrode current collector terminal 6 and the sheath 3.

A vent opening 7 which is a through hole is provided in the sheath 3. The pressure regulator 4 is attached to the sheath 3 so as to cover the vent opening 7. Further, the pressure regulator 4 is provided between an inside space 8 of the sheath 3 in which the electric storage device body 2 exists and an outside space 9 of the sheath 3. The pressure regulator 4 regulates the pressure in the inside space 8 of the sheath 3 (internal pressure of the sheath 3) by allowing release of gases (hydrogen, carbon dioxide, and the like) from the inside space 8 of the sheath 3 to the outside space 9 of the sheath 3 and blocking entry of gases (oxygen, moisture, and the like) from the outside space 9 of the sheath 3 to the inside space 8 of the sheath 3.

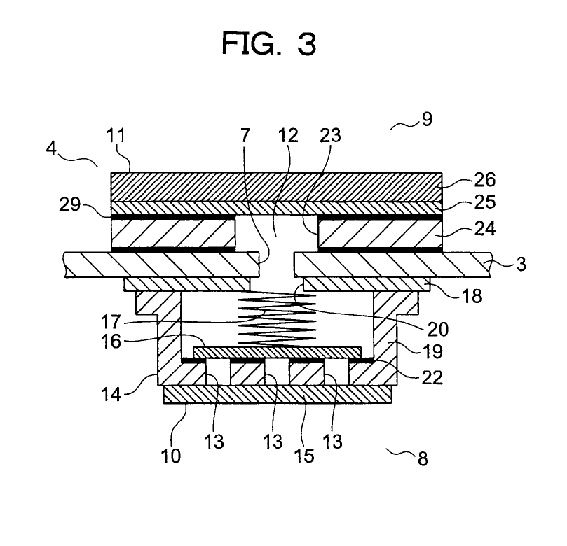

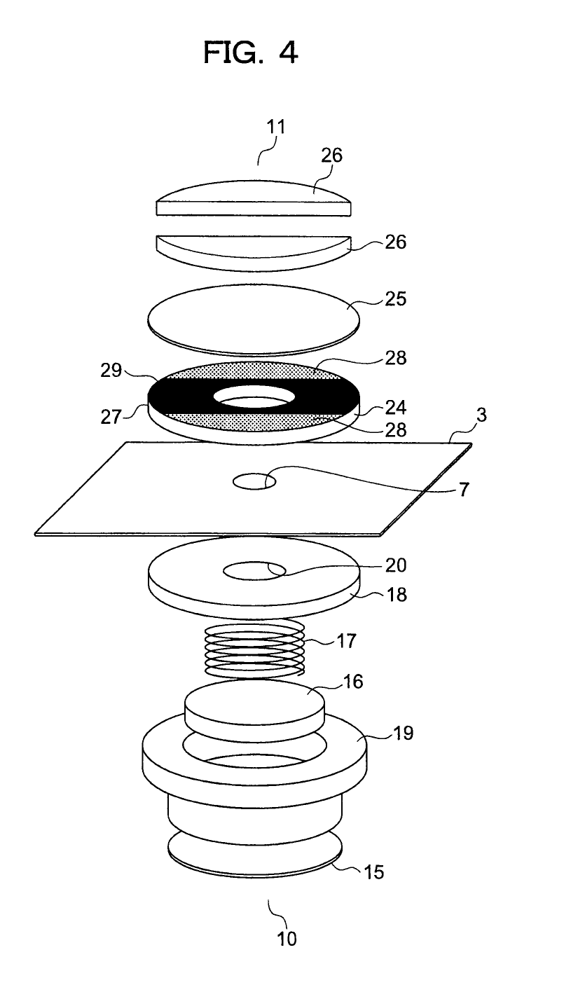

FIG. 3 is an enlarged sectional view illustrating the pressure regulator 4 of FIG. 2. FIG. 4 is an exploded perspective view illustrating the pressure regulator 4 of FIG. 3. In the figures, the pressure regulator 4 includes a first gas release mechanism portion 10 which covers the vent opening 7 from the inside of the sheath 3 (on the inside space 8 side) and a second gas release mechanism portion 11 which covers the vent opening 7 from the outside of the sheath 3 (on the outside space 9 side). More specifically, the pressure regulator 4 is a pressure regulator having a two-fold structure of the first gas release mechanism portion 10 and the second gas release mechanism portion 11. Further, the pressure regulator 4 allows release of gases from the inside space 8 to the outside space 9 by causing gases from the inside space 8 to pass through the first gas release mechanism portion 10 and the second gas release mechanism portion 11 in succession, and blocks entry of gases from the outside space 9 to the inside space 8 at each of the first gas release mechanism portion 10 and the second gas release mechanism portion 11. The gas release mechanism of the first gas release mechanism portion 10 and the gas release mechanism of the second gas release mechanism portion 11 are different from each other. Further, the first gas release mechanism portion 10 and the second gas release mechanism portion 11 are independent of each other, and thus, as the first gas release mechanism portion 10, a material which may easily block gases evolved in the inside space 8 is used, while, as the second gas release mechanism portion 11, a material which may easily block the outside air and moisture is used. This may improve the airtightness of the pressure regulator 4. More specifically, by selecting appropriate gas release mechanism portions as the first gas release mechanism portion 10 and the second gas release mechanism portion 11, respectively, the airtightness of the pressure regulator 4 becomes more satisfactory.

A buffer space 12 formed by being partitioned by the first gas release mechanism portion 10 and the second gas release mechanism portion 11 is formed between the first gas release mechanism portion 10 and the second gas release mechanism portion 11. The buffer space 12 includes a space in the vent opening 7. The first gas release mechanism portion 10 is disposed between the inside space 8 of the sheath 3 and the buffer space 12, while the second gas release mechanism portion 11 is disposed between the outside space 9 of the sheath 3 and the buffer space 12. Therefore, the second gas release mechanism portion 11 is disposed in contact with the outside air, while the first gas release mechanism portion 10 is disposed away from contact with the outside air.

The first gas release mechanism portion 10 is a gas release mechanism portion which allows passing of gases from the inside space 8 to the buffer space 12 (that is, passing of gases in a release direction from the inside space 8 to the outside space 9) and blocks passing of gases from the buffer space 12 to the inside space 8 (that is, passing of gases in an entry direction from the outside space 9 to the inside space 8), and thus, has the non-return function.

Further, the first gas release mechanism portion 10 includes a housing 14 provided with a plurality of valve housing vent holes 13, a gas-liquid separation film 15 for collectively closing the valve housing vent holes 13, a plate-like gas release valve 16 which is provided in the housing 14 and which may open and close the valve housing vent holes 13, and a compression spring (pressing member) 17 provided in the housing 14 for urging the gas release valve 16 in a direction of closing the valve housing vent holes 13.

The housing 14 includes a plate-like housing lid 18 attached to an inner surface of the sheath 3 and a cup-like housing body 19 which is fixed to the housing lid 18 and which covers the vent opening 7. The valve housing vent holes 13 are provided in the housing body 19.

The housing lid 18 is provided with an opening 20 for communication between the space in the vent opening 7 and a space in the housing body 19. The housing lid 18 is fixed to the inner surface of the sheath 3 by heat-sealing, an adhesive, or the like. The housing body 19 is fixed to the housing lid 18 by heat-sealing, an adhesive, or the like. The buffer space 12 includes, in addition to the space in the vent opening 7, a space in the opening 20 and the space in the housing body 19.

The materials of the housing lid 18 and of the housing body 19 may be anything insofar as the shapes thereof may be maintained, and, for example, a resin material, a metal material, or the like which forms the gas release valve 16 is used. When the housing lid 18 and the housing body 19 are fixed to each other by heat-sealing, by forming the housing lid 18 and the housing body 19 of the same material, the strength of the joint between the housing lid 18 and the housing body 19 may be improved. When the housing lid 18 is fixed to the inner surface of the sheath 3 by heat-sealing, by forming an inside layer of the sheath 3 and the housing lid 18 of the same material, the strength of the joint between the housing lid 18 and the sheath 3 may be improved.

The gas-liquid separation film 15 collectively closes the valve housing vent holes 13 by being bonded to an outer surface of the housing body 19 in a state of facing the inside space 8 in which the electric storage device body 2 exists. Further, the gas-liquid separation film 15 is a porous film having a plurality of minute pores provided therein. This causes the gas-liquid separation film 15 to allow passing of gases through the plurality of minute pores and to block passing of liquids such as the electrolyte solution. When the pressure of the inside space 8 of the sheath 3 rises by gases evolved from the electric storage device body 2, gases in the sheath 3 passes through the gas-liquid separation film 15 to enter the valve housing vent holes 13, and the pressures in spaces in the valve housing vent holes 13 rise in accordance with the pressure in the inside space 8.

As the gas-liquid separation film 15, a porous film formed of polytetrafluoroethylene (PTFE), perfluoroalkoxyethylene (PFA), PP, or the like is used. The gas-liquid separation film 15 is a porous film which has a contact angle of 90 degrees or more with respect to the electrolyte solution and which is oil-repellent. This enables the gas-liquid separation film 15 to maintain the stable gas-liquid separating function. The average diameter (average pore diameter) of the minute pores provided in the gas-liquid separation film 15 is preferably on the order of 0.03 μm to 5 μm, more preferably 0.1 μm to 1 μm. If the average pore diameter is larger than 5 μm, when the pressure in the inside space 8 rises, there is a possibility that the electrolyte solution in the inside space 8 passes through the gas-liquid separation film 15. Further, when the average pore diameter is smaller than 0.03 μm, it may take too much time for gases to pass through the gas-liquid separation film 15 and the pressure in the inside space 8 may rise too much.

The withstand pressure of the gas-liquid separation film 15 when the electrolyte solution passes therethrough is set to be higher than the pressure in the inside space 8 when the pressure regulator 4 allows release of gases to the outside space 9. For example, when the electric storage device 1 is under a reduced pressure, the withstand pressure of the gas-liquid separation film 15 when the electrolyte solution passes therethrough is set to be on the order of 100 kPa.

The gas release valve 16 opens and closes the valve housing vent holes 13 by being brought into and away from contact with an inner surface of the housing body 19. Further, the gas release valve 16 closes the valve housing vent holes 13 by being urged by the compression spring 17 to be pressed against the inner surface of the housing body 19.

Further, the gas release valve 16 may be adapted to open the valve housing vent holes 13 by elastic deformation of a portion thereof which is not pressed by the compression spring 17 in a direction away from the inner surface of the housing body 19, or may be adapted to open the valve housing vent holes 13 by displacement thereof in a direction away from the inner surface of the housing body 19 against the urging force of the compression spring 17.

In a normal state in which the pressure in the inside space 8 is low, the valve housing vent holes 13 are closed by the gas release valve 16 which is pressed against the inner surface of the housing body 19 by the urging force of the compression spring 17. In this state, movement of gases between the inside of the valve housing vent holes 13 and the inside of the buffer space 12 is blocked. When the pressure in the inside space 8 rises and the pressures in the valve housing vent holes 13 become higher than a predetermined value, gases in the valve housing vent holes 13 press the gas release valve 16 to elastically deforms or displaces the gas release valve 16. This causes a gap between the inner surface of the housing body 19 and the gas release valve 16 to open the valve housing vent holes 13, and passing of gases from the inside of the valve housing vent holes 13 to the buffer space 12 is allowed. When the pressures in the valve housing vent holes 13 fall by the release of gases to the buffer space 12, the gas release valve 16 returns to a position at which the gas release valve 16 closes the valve housing vent holes 13 by the urging force of the compression spring 17. This again blocks movement of gases between the inside of the valve housing vent holes 13 and the inside of the buffer space 12.

More specifically, in a normal state in which the pressure in the inside space 8 is low, the first gas release mechanism portion 10 blocks movement of gases between the inside space 8 and the buffer space 12, and, when the pressure in the inside space 8 rises, blocks passing of gases from the buffer space 12 to the inside space 8 (that is, passing of gases in the entry direction to the inside space 8) and allows passing of gases from the inside space 8 to the buffer space 12 (that is, passing of gases in the release direction to the outside space 9). Further, the first gas release mechanism portion 10 is a self-restorable check valve device which blocks entry of gases to the inside space 8 even after the release of gases from the inside space 8 to the buffer space 12 (that is, after passing of gases in the release direction to the outside space 9).

As the material of the gas release valve 16 which opens and closes the valve housing vent holes 13 by elastic deformation thereof, a rubber having a relatively high elasticity such as a fluoro rubber, an ethylene propylene rubber, a silicone rubber, a nitrile rubber, a styrene butadiene rubber, or an acrylic rubber is used. As the material of the gas release valve 16 which opens and closes the valve housing vent holes 13 by displacement thereof, a material having a relatively low elasticity is used. For example, a thermoplastic resin film formed of PP, PET, PE, PEN, PTFE, or the like, a thermosetting resin such as a phenolic resin, an epoxy resin, a melamine resin, a urea resin, a polyurethane resin, or a thermosetting polyimide resin, or a metal such as aluminum or a stainless steel is used.

A liquid sealing material 22 for hermetically sealing the gap between the housing body 19 and the gas release valve 16 when the gas release valve 16 closes the valve housing vent holes 13 is provided between the inner surface of the housing body 19 and the gas release valve 16. This may improve the airtightness of the inside space 8. In particular, when the gas release valve 16 is formed of a material having a low elasticity, it is effective to provide the sealing material 22 between the inner surface of the housing body 19 and the gas release valve 16. Note that, when the material forming the gas release valve 16 is highly airtight with the housing body 19 and thus the airtightness of the inside space 8 is secured, the sealing material 22 may be eliminated.

As the sealing material 22, for example, oil such as silicone oil, fluorine oil, or hydrocarbon oil, or silicone grease is used. For example, when the sealing material 22 is silicone oil, the kinematic viscosity of the sealing material 22 at 25° C. is preferably equal to or higher than 50 mm²/s, and more preferably equal to or higher than 1,000 mm²/s. Further, as the kinematic viscosity of the sealing material 22 becomes higher, a smaller amount of components volatizes, and thus, it is preferred to use, as the sealing material 22, silicone oil having so high kinematic viscosity that, even left under an environment in which the temperature is as high as 150° C. for a day, the volatilization amount of components is 1% or less of the whole amount.

The compression spring 17 develops an elastic repulsive force in a state of being compressed between the gas release valve 16 and the housing lid 18. The compression spring 17 urges the gas release valve 16 toward the inner surface of the housing body 19 by exerting the elastic repulsive force on the gas release valve 16. In this example, the compression spring 17 is a coil spring. As the material of the compression spring 17, for example, a metal such as a spring steel, phosphor bronze, beryllium copper, or a stainless steel, a rubber, or a synthetic resin is used. Note that, the shape of the compression spring 17 is not limited to a coil insofar as the pressing member 17 is elastic, and may be, for example, a block-like or plate-like shape.

The second gas release mechanism portion 11 is a gas release mechanism portion which allows passing of gases from the buffer space 12 to the outside space 9 (that is, passing of gases in the release direction from the inside space 8 to the outside space 9) and blocks passing of gases from the outside space 9 to the buffer space 12 (that is, passing of gases in the entry direction from the outside space 9 to the inside space 8), and thus, has the non-return function.

The second gas release mechanism portion 11 includes a circular film-like housing 24 having an opening 23 provided therein, a circular film-like gas release valve 25 adhered so as to be overlaid on the housing 24 and so as to cover the opening 23, and a pair of reinforcing members 26 adhered so as to be overlaid on a part of the gas release valve 25.

The entire rear surface (lower surface) of the housing 24 is attached to the outer surface of the sheath 3 by heat-sealing, an adhesive, or the like. The inside diameter of the opening 23 is larger than the inside diameter of the vent opening 7. The opening 23 is positioned so as to wholly cover the vent opening 7 as seen along a thickness direction of the housing 24. As the material of the housing 24, for example, the material which forms the housing 14 of the first gas release mechanism portion 10 is used. The buffer space 12 includes a space in the opening 23.

A gas passage region 27 which passes above the opening 23 to reach the rim of the housing 24 is set on a front surface (upper surface) of the housing 24. The gas release valve 25 is bonded to the front surface of the housing 24 by an adhesive 28 applied to the housing 24 except for the gas passage region 27. Further, the gas release valve 25 is formed of an elastically deformable material. As the material of the gas release valve 25, for example, the material which forms the gas release valve 16 of the first gas release mechanism portion 10 is used.

A liquid sealing material 29 exists in the gas passage region 27. A gap between the front surface of the housing 24 and the gas release valve 25 in the gas passage region 27 is hermetically sealed by the liquid sealing material 29. As the sealing material 29, for example, a material similar to the sealing material 22 of the first gas release mechanism portion 10 is used. Further, the liquid sealing material 29 of the second gas release mechanism portion 11 may be brought into contact with the outside air, and thus, it is preferred to use a material which is highly water-resistant and oxidation-resistant. By using fluorine-modified silicone oil or fluorine-based oil, longer-term sealing may be expected.

Each of the reinforcing members 26 is disposed at a position at which the adhesive 28 is applied when the second gas release mechanism portion 11 is seen along the thickness direction of the housing 24. Specifically, the reinforcing members 26 are disposed so as not to overlap the gas passage region 27 when the second gas release mechanism portion 11 is seen along the thickness direction of the housing 24. As the material of the reinforcing members 26, for example, the material which forms the housing 14 of the first gas release mechanism portion 10 is used. The gas release valve 25 is less liable to be folded (less liable to be elastically deformed) at portions to which the reinforcing members 26 are bonded, and is more liable to be folded (more liable to be elastically deformed) at portions away from the reinforcing members 26.

In a normal state in which the pressure in the buffer space 12 is low, the gap between the gas release valve 25 and the housing 24 in the gas passage region 27 is hermetically sealed by the sealing material 29. In this state, movement of gases between the buffer space 12 and the outside space 9 is blocked. When the pressure in the buffer space 12 rises and becomes higher than a predetermined value, the portion of the gas release valve 25 to which the reinforcing members 26 are not bonded is pressed by gases in the buffer space 12 to be curved. This causes a gap in the gas passage region 27 between the gas release valve 25 and the housing 24, which allows passing of gases from the buffer space 12 to the outside space 9 (that is, passing of gases in the release direction to the outside space 9). When the pressure in the buffer space 12 falls by the release of gases to the outside space 9, the deformed gas release valve 25 returns to its original shape by the elastic restoring force of the gas release valve 25 and the state returns to the state in which the gap between the gas release valve 25 and the housing 24 is hermetically sealed by the sealing material 29. This again blocks the movement of gases between the buffer space 12 and the outside space 9.

Specifically, in the normal state in which the pressure in the buffer space 12 is low, the second gas release mechanism portion 11 blocks the movement of gases between the buffer space 12 and the outside space 9, and, when the pressure in the buffer space 12 rises, the second gas release mechanism portion 11 blocks the passing of gases from the outside space 9 to the buffer space 12 (that is, the passing of gases in the entry direction to the inside space 8) and allows the passing of gases from the buffer space 12 to the outside space 9 (that is, the passing of gases in the release direction to the outside space 9). Further, the second gas release mechanism portion 11 is a self-restorable check valve device which blocks the entry of gases to the inside space 8 even after the release of gases from the buffer space 12 to the outside space 9 (that is, after the passing of gases in the release direction to the outside space 9).

Next, operation is described. In the electric storage device 1, when the electric storage device body 2 is repeatedly charged and discharged, because of a side reaction due to remaining moisture or impurities, gases are evolved from the electric storage device body 2, and the pressure in the inside space 8 of the sheath 3 gradually rises. Gases in the inside space 8 of the sheath 3 pass through the gas-liquid separation film 15, and thus, the pressures in the valve housing vent holes 13 also gradually rise according to the pressure in the inside space 8.

When the pressures in the valve housing vent holes 13 become higher than the predetermined value, gases in the valve housing vent holes 13 push up the gas release valve 16 against the urging force of the compression spring 17, and the gases are passed from the valve housing vent holes 13 to the buffer space 12. When the pressure in the inside space 8 falls by the release of the gases to the buffer space 12, the displaced gas release valve 16 returns to its original position, and the valve housing vent holes 13 are again closed by the gas release valve 16.

After that, when the pressure in the buffer space 12 becomes higher than the predetermined value by the entry of the gases to the buffer space 12, a part of the gas release valve 25 is pressed by the gases in the buffer space 12 to be curved, which provides a gap between the gas release valve 25 and the housing 24. This releases the gases from the buffer space 12 to the outside space 9.

After that, when the pressure in the buffer space 12 falls by the release of the gases to the outside space 9, the deformed gas release valve 25 returns to its original shape, which causes the gap between the gas release valve 25 and the housing 24 to be hermetically sealed by the sealing material 29.

Usually, when the electric storage device 1 is used for a long term, the function of the second gas release mechanism portion 11 in contact with the outside air is more liable to be deteriorated than the function of the first gas release mechanism portion 10 disposed away from contact with the outside air. Therefore, even when the function of the second gas release mechanism portion 11 is deteriorated and gases enter the buffer space 12 from the outside space 9, the first gas release mechanism portion 10 blocks entry of the gases from the buffer space 12 to the inside space 8. Further, by using a material which is resistant to moisture for the second gas release mechanism portion 11 in contact with the outside air, the durability of the second gas release mechanism portion 11 may be improved. On the other hand, by using a material which is resistant to gases inside and vapor of the electrolyte solution for the first gas release mechanism portion 10, the durability of the first gas release mechanism portion 10 may be improved. In particular, by using a material which is resistant to the electrolyte solution for the gas release valve 16 of the first gas release mechanism portion 10 and using a material which is resistant to water for the gas release valve 25 of the second gas release mechanism portion 11, the airtightness and the non-return function may be maintained for a long term. As described above, in the plurality of gas release mechanism portions 10 and 11, the gas release valve 16 of the gas release mechanism portion 10 disposed in the inside space 8 and the gas release valve 25 of the gas release mechanism portion 11 disposed in the outside space are formed of different materials which are suitable for the first gas release mechanism portion 10 and the second gas release mechanism portion 11, respectively, and hence the reliability of the pressure regulator 4 may be secured for a long term.

In the electric storage device 1 described above, the passing of gases from the inside space 8 through the first gas release mechanism portion 10 and the second gas release mechanism portion 11 in succession allows the release of gases from the inside space 8 to the outside space 9, and the entry of gases from the outside space 9 to the inside space 8 is blocked by each of the first gas release mechanism portion 10 and the second gas release mechanism portion 11. The buffer space 12 formed by being partitioned by the first gas release mechanism portion 10 and the second gas release mechanism portion 11 is formed between the first gas release mechanism portion 10 and the second gas release mechanism portion 11. Thus, even when the function of one of the first gas release mechanism portion 10 and the second gas release mechanism portion 11 is deteriorated, the entry of gases to the inside space 8 can be blocked by the other gas release mechanism portion whose function is not deteriorated. Further, the first gas release mechanism portion 10 is disposed away from contact with the outside air, and thus, condensed water is less liable to be generated in the first gas release mechanism portion 10, and the function deterioration of the first gas release mechanism portion 10 may be suppressed. This enables long-term blocking of the entry of gases from the outside space 9 via the pressure regulator 4 to the inside space 8, to thereby suppress the function deterioration of the pressure regulator 4 for a long term.

Further, the kinematic viscosities of the sealing materials 22 and 29, which are provided between the gas release valve 16 and the housing 14 and between the gas release valve 25 and the housing 24, respectively, are equal to or higher than 50 mm²/s, and thus, the airtight state of the gap between the gas release valve 16 and the housing 14 and of the gap between the gas release valve 25 and the housing 24 may be secured more, and the reliability of the function of the first gas release mechanism portion 10 and the function of the second gas release mechanism portion 11 may be improved.

Further, the second gas release mechanism portion 11 covers the vent opening 7 provided in the sheath 3 from the outside of the sheath 3, and thus, the entry of gases to the first gas release mechanism portion 10 may be easily blocked. Further, even when the function of the second gas release mechanism portion 11 is deteriorated and replacement is necessary, the deteriorated second gas release mechanism portion 11 may be easily replaced by a new second gas release mechanism portion 11.

Note that, in the above-mentioned example, the housing lid 18 is fixed to the inner surface of the sheath 3 and the housing body 19 is fixed to the housing lid 18, but the housing lid 18 may be fixed to the inside of the housing body 19 and the housing body 19 may be fixed to the inner surface of the sheath 3.

Further, in the above-mentioned example, the second gas release mechanism portion 11 does not have a gas-liquid separation film, but the second gas release mechanism portion 11 may have a gas-liquid separation film.

### Second Embodiment

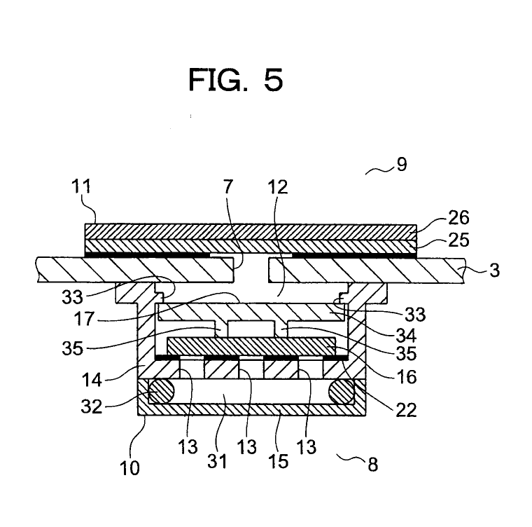

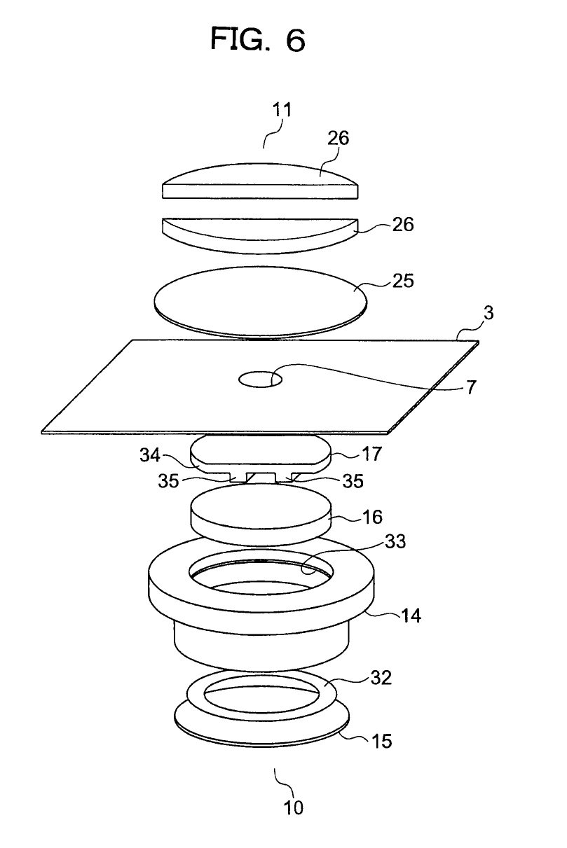

FIG. 5 is a sectional view illustrating a pressure regulator of an electric storage device according to a second embodiment of the present invention. FIG. 6 is an exploded perspective view illustrating the pressure regulator of FIG. 5. In the figures, the first gas release mechanism portion 10 and the second gas release mechanism portion 11 are gas release mechanism portions which allow passing of gases in the release direction from the inside space 8 to the outside space 9 and block passing of gases in the entry direction from the outside space 9 to the inside space 8, and thus, have the non-return function.

The first gas release mechanism portion 10 is, similarly to the first gas release mechanism portion 10 of the first embodiment, a self-restorable check valve device which maintains the function of blocking the entry of gases to the inside space 8 even after the release of gases from the inside space 8 to the buffer space 12 (that is, after the passing of gases in the release direction to the outside space 9). On the other hand, the second gas release mechanism portion 11 is, differently from the second gas release mechanism portion 11 of the first embodiment, anon-self-restorable burst valve device which loses the function of blocking the entry of gases to the buffer space 12 (that is, the passing of gases in the entry direction to the inside space 8) after the release of gases from the buffer space 12 to the outside space 9 (that is, after the passing of gases in the release direction to the outside space 9).

The first gas release mechanism portion 10 includes the cup-like housing 14 provided with the plurality of valve housing vent holes 13, the gas-liquid separation film 15 for collectively covering the valve housing vent holes 13, the plate-like gas release valve 16 which is provided in the housing 14 and which may open and close the valve housing vent holes 13, the pressing member 17 provided in the housing 14 for urging the gas release valve 16 in a direction of closing the valve housing vent holes 13, and a ring-like spacer 32 provided between the housing 14 and the gas-liquid separation film 15 for forming an in-valve space 31 between the housing 14 and the gas-liquid separation film 15.

The housing 14 does not have the housing lid 18 of the first embodiment, and is attached to the inner surface of the sheath 3 by heat-sealing, an adhesive, or the like so as to cover the vent opening 7. A protrusion 33 which protrudes inward in a diameter direction of the housing 14 is provided on an inner surface of the housing 14 over the entire inner periphery of the housing 14. The material of the housing 14 is similar to the material of the housing 14 of the first embodiment.

Only the rim of the gas-liquid separation film 15 is attached to the housing 14. The gas-liquid separation film 15 except for the rim thereof is disposed away from the housing 14 with the spacer 32 provided therebetween. This forms the in-valve space 31 between the gas-liquid separation film 15 except for the rim thereof and the housing 14. With this, the gas-liquid separation film 15 is less liable to become wet by the liquid sealing material 22, and hence the gas transmission characteristics of the gas-liquid separation film 15 is maintained. In particular, when the contact angle of the gas-liquid separation film 15 with respect to oil (for example, silicone oil) is 90 degrees or more and the gas-liquid separation film 15 does not exhibit oil repellency, if the gas-liquid separation film 15 become wet by the oil, the gas transmission characteristics of the gas-liquid separation film 15 is considerably deteriorated. Thus, the spacer 32 suppresses deterioration of the gas transmission characteristics of the gas-liquid separation film 15 with more reliability. Further, even when the pressure in the inside space 8 rises and the electrolyte solution passes through the gas-liquid separation film 15, the electrolyte solution is stored in the in-valve space 31, and hence the gas passageway in the gas-liquid separation film 15 is secured to suppress deterioration of the gas transmission characteristics of the gas-liquid separation film 15. As the gas-liquid separation film 15, a film similar to the gas-liquid separation film 15 of the first embodiment is used.

The spacer 32 is disposed so as to surround a region in which the valve housing vent holes 13 are provided. As the material of the spacer 32, for example, a rubber or a resin is used. In this example, the spacer 32 is an O ring. The structure of the gas release valve 16 is similar to the structure of the gas release valve 16 of the first embodiment.

The pressing member 17 includes an engaging plate portion 34 which engages with the protrusion 33 of the housing 14 and a plurality of pressing portions 35 which protrude from the engaging plate portion 34 toward the gas release valve 16. The pressing member 17 urges the gas release valve 16 in the direction of closing the valve housing vent holes 13 by pressing the pressing portions 35 against the gas release valve 16 in the state in which the engaging plate portion 34 is engaged with the protrusion 33. As the pressing member 17, for example, a molded body formed of a rubber, a thermoplastic resin, a thermosetting resin, a metal, or the like is used. Other points of the structure and operation of the first gas release mechanism portion 10 are similar to those of the first embodiment.

The second gas release mechanism portion 11 includes a circular film-like gas release valve 25 bonded to the outer surface of the sheath 3 from the outside of the sheath 3 so as to cover the vent opening 7, and a pair of reinforcing members 26 bonded so as to be overlaid on a part of the gas release valve 25.

The entire rear surface (lower surface) of the gas release valve 25 is bonded to the outer surface of the sheath 3 by an adhesive. The portion of the rear surface of the gas release valve 25 to which the adhesive is applied is at least a portion which surrounds the entire periphery of the vent opening 7. As the material of the gas release valve 25, the material which forms the gas release valve 16 of the first gas release mechanism portion 10 or the like is used.

Each of the reinforcing members 26 is bonded onto the gas release valve 25 so as not to overlap the vent opening 7. As the material of the reinforcing members 26, for example, the material which forms the housing 14 of the first gas release mechanism portion 10 is used. The gas release valve 25 is less liable to be folded (less liable to be elastically deformed) at portions to which the reinforcing members 26 are bonded, and is more liable to be folded (more liable to be elastically deformed) at portions away from the reinforcing members 26.

When the pressure in the buffer space 12 rises and becomes higher than a predetermined value, the gas release valve 25 is pressed by gases in the buffer space 12, which peels off the portion of the gas release valve 25 to which the reinforcing members 26 are not bonded from the outer surface of the sheath 3. By the peeling off of the gas release valve 25 from the outer surface of the sheath 3, a bypass for gases is formed between the gas release valve 25 and the sheath 3 to release the gases in the buffer space 12 to the outside space 9. When the pressure in the buffer space 12 falls by the release of the gases to the outside space 9, the gas release valve 25 does not return to its original position and the bypass for the gases is not closed. In other words, in the second gas release mechanism portion 11, after the passing of gases in the release direction to the outside space 9, the function of blocking the entry of gases to the buffer space 12 (inside space 8) is lost. Other points of the structure and operation are similar to those of the first embodiment.

In the electric storage device 1 described above, the first gas release mechanism portion 10 is a self-restorable check valve device which maintains the function of blocking the entry of gases to the inside space 8 even after the passing of gases in the release direction to the outside space 9, while the second gas release mechanism portion 11 is a non-self-restorable burst valve device which loses the function of blocking the entry of gases to the inside space 8 after the passing of gases in the release direction to the outside space 9. Therefore, before the second gas release mechanism portion 11 which is a burst valve device is activated, the airtightness of the inside space 8 may be maintained at a high level. Specifically, usually, the airtightness by a burst valve device is higher than the airtightness by a check valve device, and thus, when the second gas release mechanism portion 11 is a burst valve device, the airtightness of the inside space 8 before the second gas release mechanism portion 11 is activated may be at a high level.

Further, the second gas release mechanism portion 11 which is a burst valve device is attached to the outer surface of the sheath 3 from the outside of the sheath 3, and thus, the activated second gas release mechanism portion 11 may be easily restored.

Further, the spacer 32 for forming the in-valve space 31 between the housing 14 and the gas-liquid separation film 15 is provided between the housing 14 and the gas-liquid separation film 15, and thus, the deterioration of the gas transmission characteristics of the gas-liquid separation film 15 when becoming wet by the sealing material 22 may be suppressed.

### Third Embodiment

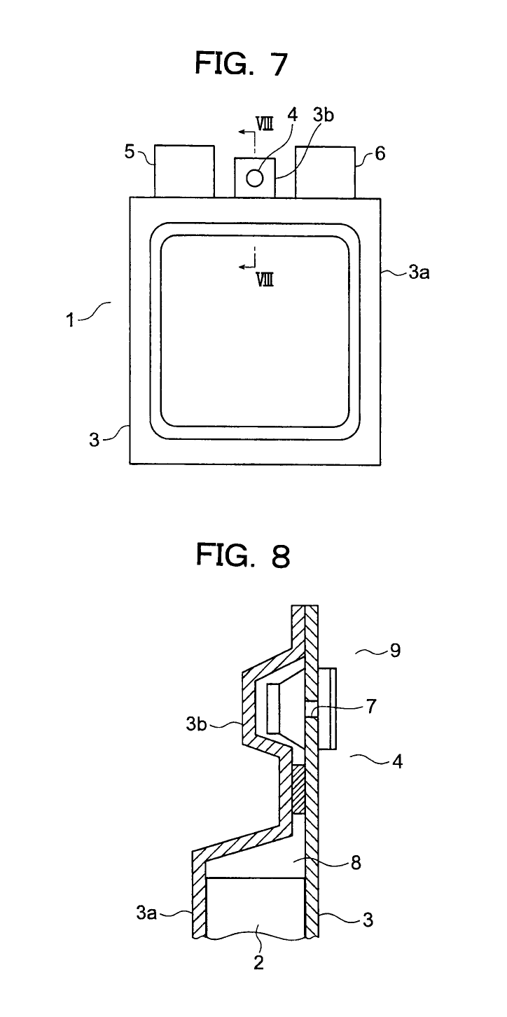

FIG. 7 is a front view illustrating an electric storage device according to a third embodiment of the present invention. FIG. 8 is a sectional view taken along the line VIII-VIII of FIG. 7. In the figures, the sheath 3 includes a sheath body 3a for housing the electric storage device body 2 and a sheath protruding portion 3b which protrudes from the sheath body 3a and which is provided with the pressure regulator 4.

The sheath 3 is manufactured by overlaying one sheet having a narrow protruding portion on another (for example, aluminum laminate sheets) and heat-sealing the rims of the sheets. In the sheath 3, the portion at which the protruding portions of the sheets are overlaid is the sheath protruding portion 3b. The vent opening 7 is provided in the sheath protruding portion 3b.

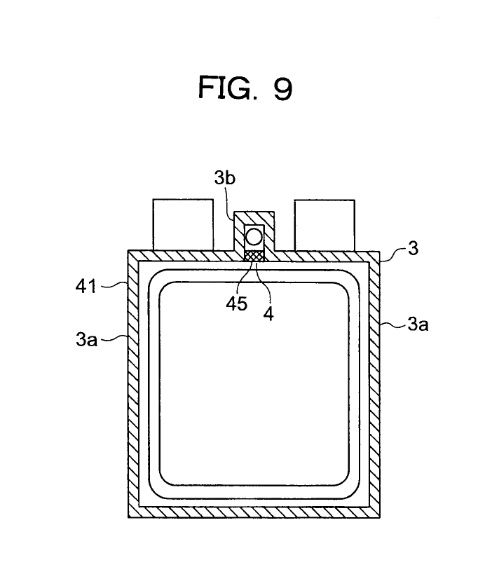

FIG. 9 is a front view illustrating a heat-sealed portion of two sheets which form the sheath 3 of FIG. 7. As illustrated in FIG. 9, a heat-sealed portion 41 is formed along the rims of the sheath body 3a and the sheath protruding portion 3b. The pressure regulator 4 is provided in the sheath protruding portion 3b inside the heat-sealed portion 41.

As illustrated in FIG. 8, the pressure regulator 4 is disposed between the inside space 8 of the sheath 3 in which the electric storage device body 2 exists and the outside space 9 of the sheath 3. Further, the pressure regulator 4 regulates the pressure in the inside space 8 of the sheath 3 by allowing release of gases from the inside space 8 of the sheath 3 to the outside space 9 of the sheath 3 and blocking entry of gases from the outside space 9 of the sheath 3 to the inside space 8 of the sheath 3.

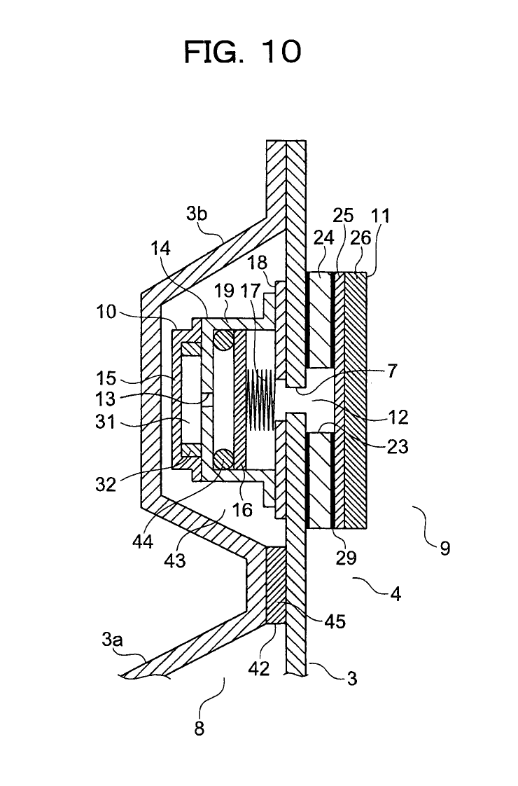

FIG. 10 is an enlarged sectional view illustrating the pressure regulator 4 of FIG. 8. In the figure, the pressure regulator 4 includes the first gas release mechanism portion 10 which covers the vent opening 7 from the inside of the sheath 3 (on the inside space 8 side), the second gas release mechanism portion 11 which covers the vent opening 7 from the outside of the sheath 3 (on the outside space 9 side), and a third gas release mechanism portion 42 disposed in the sheath 3 at a position which is nearer to the electric storage device body 2 with respect to the first gas release mechanism portion 10. Specifically, the pressure regulator 4 is a pressure regulator having a three-fold structure of the first gas release mechanism portion 10, the second gas release mechanism portion 11, and the third gas release mechanism portion 42. The pressure regulator 4 allows the release of gases from the inside space 8 to the outside space 9 by causing the gases from the inside space 8 to pass through the third gas release mechanism portion 42, the first gas release mechanism portion 10, and the second gas release mechanism portion 11 in succession, and blocks the entry of gases from the outside space 9 to the inside space 8 at each of the first gas release mechanism portion 10, the second gas release mechanism portion 11, and the third gas release mechanism portion 42.

The buffer space 12 formed by being partitioned by the first gas release mechanism portion 10 and the second gas release mechanism portion 11 is formed between the first gas release mechanism portion 10 and the second gas release mechanism portion 11. A buffer space 43 formed by being partitioned by the third gas release mechanism portion 42 and the first gas release mechanism portion 10 is formed between the third gas release mechanism portion 42 and the first gas release mechanism portion 10. The second gas release mechanism portion 11 is disposed between the outside space 9 and the buffer space 12, the first gas release mechanism portion 10 is disposed between the buffer space 12 and the buffer space 43, and the third gas release mechanism portion 42 is disposed between the buffer space 43 and the inside space 8. Therefore, the second gas release mechanism portion 11 is disposed in contact with the outside air, while the first gas release mechanism portion 10 and the third gas release mechanism portion 42 are disposed away from contact with the outside air.

The first gas release mechanism portion 10 is a gas release mechanism portion which allows passing of gases from the buffer space 43 to the buffer space 12 (that is, passing of gases in the release direction from the inside space 8 to the outside space 9) and blocks passing of gases from the buffer space 12 to the buffer space 43 (that is, passing of gases in the entry direction from the outside space 9 to the inside space 8), and thus, has the non-return function. Further, the first gas release mechanism portion 10 is a self-restorable check valve device which blocks entry of gases to the buffer space 43 (that is, passing of gases in the entry direction to the inside space 8) even after the release of gases from the buffer space 43 to the buffer space 12 (that is, after passing of gases in the release direction to the outside space 9).

The ring-like spacer 32 is provided between the gas-liquid separation film 15 and the housing body 19 of the first gas release mechanism portion 10 for forming the in-valve space 31 between the gas-liquid separation film 15 and the housing body 19. The rim of the gas-liquid separation film 15 is joined to the housing body 19 by heat-sealing. The portion of the gas-liquid separation film 15 except for the rim is maintained away from the housing body 19 by the spacer 32. This causes the electrolyte solution to be stored in the in-valve space 31 even when the electrolyte solution passes through the gas-liquid separation film 15 to secure the gas passageway in the gas-liquid separation film 15.

A ring-like sealing member 44 for hermetically sealing the gap between the housing body 19 and the gas release valve 16 when the gas release valve 16 closes the valve housing vent hole 13 is provided between the inner surface of the housing body 19 and the gas release valve 16. The airtightness of the gap between the housing body 19 and the gas release valve 16 is maintained by the gas release valve 16 pressed via the sealing member 44 against the inner surface of the housing body 19. As the sealing member 44, for example, an O ring formed of a rubber or a resin is used. Other points of the structure of the first gas release mechanism portion 10 are similar to those of the first gas release mechanism portion 10 of the first embodiment.

The structure of the second gas release mechanism portion 11 is similar to the structure of the second gas release mechanism portion 11 of the first embodiment. Therefore, the second gas release mechanism portion 11 is a gas release mechanism portion which allows passing of gases from the buffer space 12 to the outside space 9 (that is, passing of gases in the release direction from the inside space 8 to the outside space 9) and blocks passing of gases from the outside space 9 to the buffer space 12 (that is, passing of gases in the entry direction from the outside space 9 to the inside space 8), and thus, has the non-return function. Further, the second gas release mechanism portion 11 is a self-restorable check valve device which blocks entry of gases to the inside space 8 even after the release of gases from the buffer space 12 to the outside space 9 (that is, after passing of gases in the release direction to the outside space 9).

The third gas release mechanism portion 42 is a gas release mechanism portion which allows passing of gases from the inside space 8 to the buffer space 43 (that is, passing of gases in the release direction from the inside space 8 to the outside space 9) and blocks passing of gases from the buffer space 43 to the inside space 8 (that is, passing of gases in the entry direction from the outside space 9 to the inside space 8), and thus, has the non-return function. Further, the third gas release mechanism portion 42 is a non-self-restorable burst valve device which loses the function of blocking entry of gases to the buffer space 43 (inside space 8) after the release of gases from the inside space 8 to the buffer space 43 (that is, after passing of gases in the release direction to the outside space 9).

The third gas release mechanism portion 42 includes a gas release valve 45 which is sandwiched between the sheets of the sheath 3 and which is a partition between the inside space 8 and the buffer space 43. The gas release valve 45 is bonded to the inner surfaces of the sheets of the sheath 3 sandwiching the gas release valve 45 by heat-sealing, an adhesive, or the like. As illustrated in FIG. 9, the gas release valve 45 is disposed at the base of the sheath protruding portion 3b. The space in the sheath 3 is partitioned by the gas release valve 45 into the buffer space 43 and the inside space 8. The strength of the joint between the gas release valve 45 and the inner surfaces of the sheath 3 is set to be lower than the withstand pressure of the sheath 3. Therefore, when the pressure in the inside space 8 of the sheath 3 rises, the gas release valve 45 is adapted to peel off the inner surface of the sheath 3 before the sheath 3 breaks. As the material of the gas release valve 45, for example, the material which forms the gas release valve 25 of the second gas release mechanism portion 11 is used, and, a resin, a rubber, a metal, or the like is used.

When the gas release valve 45 of the third gas release mechanism portion 42 and the inner surfaces of the sheath 3 are joined by heat-sealing, an interposition may be provided between the gas release valve 45 and the sheath 3. The material of the interposition may be, for example, an easy adhesion resin such as an ethylene-vinyl acetate copolymer resin (EVA) in which vinyl acetate is copolymerized with ethylene. Generally, joining of different kinds of materials by heat-sealing is difficult, but, by providing an interposition formed of EVA between the gas release valve 45 and the sheath 3, heat-sealing may be carried out. In a specific example, the gas release valve 45 is formed of a film in which a PP resin is blended into a PE resin and the inside layer of the sheath 3 is a PP resin layer. The strengths of the heat-sealing between interfaces of the inside layer material of the sheath 3 and the EVA and between interfaces of the material of the gas release valve 45 and the EVA are lower than the withstand pressure of the sheath 3.

When the pressure in the inside space 8 rises, the sheath 3 bulges and pressure is applied to the inner surfaces of the sheath 3 in directions away from the gas release valve 45 of the third gas release mechanism portion 42. When the pressure in the inside space 8 further rises and becomes higher than a predetermined value, the inner surface of the sheath 3 peels off the gas release valve 45. By the peeling off of the inner surface of the sheath 3 from the gas release valve 45, a gap is formed between the gas release valve 45 and the sheath 3, and the inside space 8 and the buffer space 43 communicate with each other through the gap formed. This causes gases to pass from the inside space 8 to the buffer space 43 (that is, in the release direction to the outside space 9) to lower the pressure in the inside space 8. When the pressure in the inside space 8 falls, the gas release valve 45 is not bonded to the inner surface of the sheath 3 again. Therefore, the gap between the gas release valve 45 and the sheath 3 is not closed. In other words, in the third gas release mechanism portion 42, after passing of gases in the release direction to the outside space 9, the function of blocking entry of gases to the inside space 8 is lost. Other points of the structure and operation are similar to those of the first embodiment.

In the electric storage device 1 described above, the third gas release mechanism portion 42 is disposed at a position which is nearer to the electric storage device body 2 than the first gas release mechanism portion 10 is, and the buffer space 43 is formed between the first gas release mechanism portion 10 and the third gas release mechanism portion 42, and thus, the pressure regulator 4 may be a pressure regulator having a three-fold structure of the first gas release mechanism portion 10, the second gas release mechanism portion 11, and the third gas release mechanism portion 42. This may increase the number of the gas release mechanism portions disposed away from contact with the outside air, and the function deterioration of the pressure regulator 4 may be suppressed for a longer time. Further, the third gas release mechanism portion 42 is a non-self-restorable burst valve device which loses the function of blocking entry of gases to the inside space 8 after passing of gases in the release direction to the outside space 9, and thus, the airtightness of the inside space 8 before the third gas release mechanism portion 42 is activated may be maintained at a high level.

### Fourth Embodiment

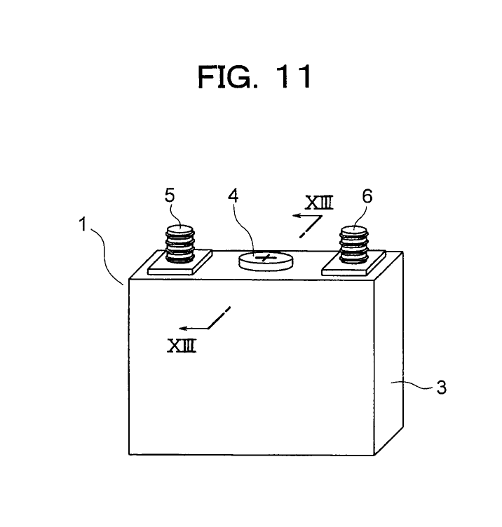

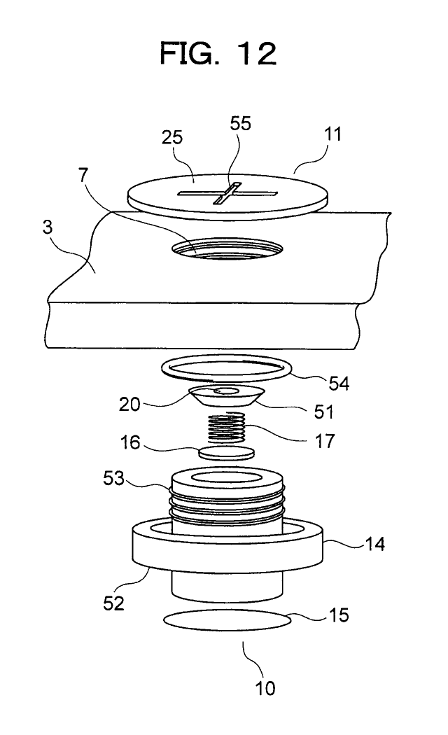

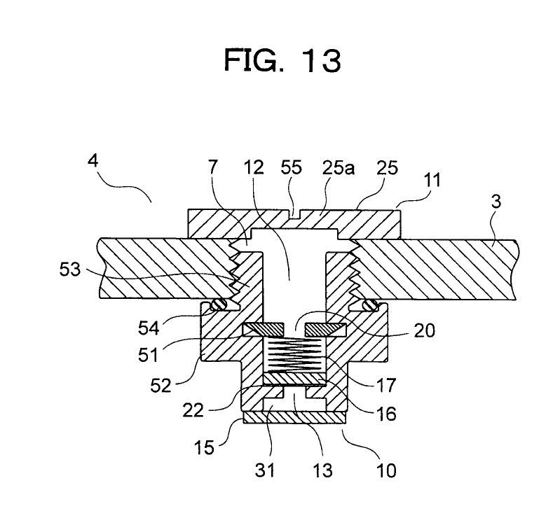

FIG. 11 is a perspective view illustrating an electric storage device according to a fourth embodiment of the present invention. FIG. 12 is an exploded perspective view illustrating a pressure regulator of FIG. 11. FIG. 13 is a sectional view taken along the line XIII-XIII of FIG. 11.

In the figures, the first gas release mechanism portion 10 is, similarly to the first gas release mechanism portion 10 of the first embodiment, a self-restorable check valve device which maintains the function of blocking entry of gases to the inside space 8 even after the release of gases from the inside space 8 to the buffer space 12. On the other hand, the second gas release mechanism portion 11 is a non-self-restorable burst valve device which loses the function of blocking entry of gases to the buffer space 12 after the release of gases from the buffer space 12 to the outside space 9.

The first gas release mechanism portion 10 includes the housing 14 provided with the valve housing vent hole 13, the gas-liquid separation film 15 for covering the valve housing vent hole 13, the plate-like gas release valve 16 which is provided in the housing 14 and which may open and close the valve housing vent hole 13, the pressing member 17 provided in the housing 14 for urging the gas release valve 16 in the direction of closing the valve housing vent hole 13, and a detachment prevention lid 51 provided in the housing 14 for holding the pressing member 17 in the housing 14.

The sheath 3 is a container formed of a metal. A female thread portion is provided in the inner periphery of the vent opening 7 provided in the sheath 3. The housing 14 includes a housing body 52 provided with the valve housing vent hole 13 and a cylindrical protrusion 53 for attachment which protrudes from the housing body 52 and which has provided on the rim thereof a male thread portion to be screwed into the female thread portion in the vent opening 7. The housing 14 is attached to the inner surface of the sheath 3 by screwing the protrusion 53 for attachment into the vent opening 7. An O ring (sealing member) 54 is provided between the inner surface of the sheath 3 and the housing body 52. This seals a gap between the inner surface of the sheath 3 and the housing 14.

Here, the material of the housing 14 is similar to the material of the housing 14 of the first embodiment, and a plastic material, a metal material, or the like is used. The material of the sheath 3 is a material which is not broken even the internal pressure rises to 100 kPa or higher and may maintain the shape thereof on its own. As the material of the sheath 3, for example, a metal material such as a stainless steel or aluminum or a plastic material is used.

Only the rim of the gas-liquid separation film 15 is attached to the housing body 52. The gas-liquid separation film 15 except for the rim thereof is disposed away from the housing 14. This forms the in-valve space 31 between the gas-liquid separation film 15 except for the rim thereof and the housing body 52. Further, even when the pressure in the inside space 8 rises and the electrolyte solution passes through the gas-liquid separation film 15, by the electrolyte solution stored in the in-valve space 31, the gas passageway in the gas-liquid separation film 15 is secured to suppress deterioration of the gas transmission characteristics of the gas-liquid separation film 15. As the gas-liquid separation film 15, a film similar to the gas-liquid separation film 15 of the first embodiment is used.

The detachment prevention lid 51 is held in a space inside the housing body 52 with the rim thereof being fit into a depression provided in an inner surface of the housing body 52. The space inside the housing 14 is partitioned by the detachment prevention lid 51. The detachment prevention lid 51 is provided with the opening 20 for communication between two spaces in the housing 14 partitioned by the detachment prevention lid 51. The buffer space 12 includes the space in the vent opening 7, the space in the housing body 52, and a space in the protrusion 53 for attachment. As the material of the detachment prevention lid 51, a material similar to the material of the housing lid 18 of the first embodiment is used. In this example, the material of the detachment prevention lid 51 is a hard rubber.

The pressing member (compression spring) 17 is disposed in a state of being compressed between the detachment prevention lid 51 and the gas release valve 16. This causes the pressing member 17 to press the gas release valve 16 in the direction of closing the valve housing vent hole 13 in the housing 14 in a state of being pressed by the detachment prevention lid 51. In this example, the pressing member 17 is a spring. As the material of the gas release valve 16, a rubber or the like is used.

The second gas release mechanism portion 11 includes the gas release valve 25 which is attached by welding to the outer surface of the sheath 3 from the outside of the sheath 3 so as to cover the vent opening 7, and hermetically seals the sheath 3. The gas release valve 25 is metal foil having a thin-walled portion 25a the thickness of which is smaller than that of other portions. A cruciate depressed portion (burst starting point portion) 55 as a starting point of a burst is provided in the thin-walled portion 25a of the gas release valve 25. The thin-walled portion 25a and the burst starting point portion 55 are formed by press-molding the metal foil. The shape of the burst starting point portion 55 is not limited to a cross, and may be anything insofar as the burst starting point portion 55 is caused to be a starting point of a burst.

When the pressure in the buffer space 12 rises and becomes higher than a predetermined value, the gas release valve 25 is broken with the burst starting point portion 55 of the gas release valve 25 being the starting point, and gases in the buffer space 12 are released to the outside space 9. When the pressure in the buffer space 12 falls by the release of gases to the outside space 9, the gas release valve 25 does not return to its original position and the bypass for gases is not closed. In other words, in the second gas release mechanism portion 11, after passing of gases in the release direction to the outside space 9, the function of blocking entry of gases to the buffer space 12 (inside space 8) is lost. Other points of the operation are similar to those of the second embodiment.

In the electric storage device 1 described above, the first gas release mechanism portion 10 is a self-restorable check valve device which maintains the function of blocking entry of gases to the inside space 8 even after passing of gases in the release direction to the outside space 9, while the second gas release mechanism portion 11 is a non-self-restorable burst valve device which loses the function of blocking entry of gases to the inside space 8 after passing of gases in the release direction to the outside space 9. Therefore, before the second gas release mechanism portion 11 which is a burst valve device is activated, the airtightness of the inside space 8 may be maintained at a high level. More specifically, usually, airtightness by a burst valve device is higher than airtightness by a check valve device, and thus, when the second gas release mechanism portion 11 is a burst valve device, the airtightness of the inside space 8 before the second gas release mechanism portion 11 is activated may be at a high level.

Further, the second gas release mechanism portion 11 which is a burst valve device is attached to the outer surface of the sheath 3 from the outside of the sheath 3, and thus, the activated second gas release mechanism portion 11 may be restored.

### Fifth Embodiment

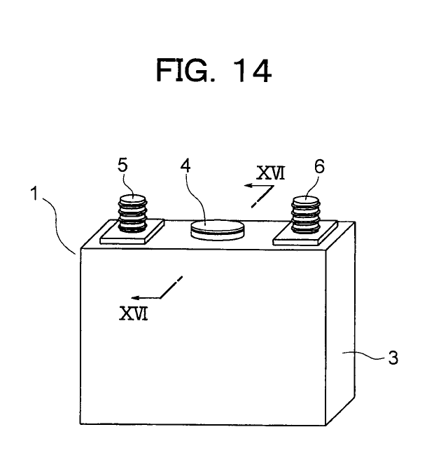

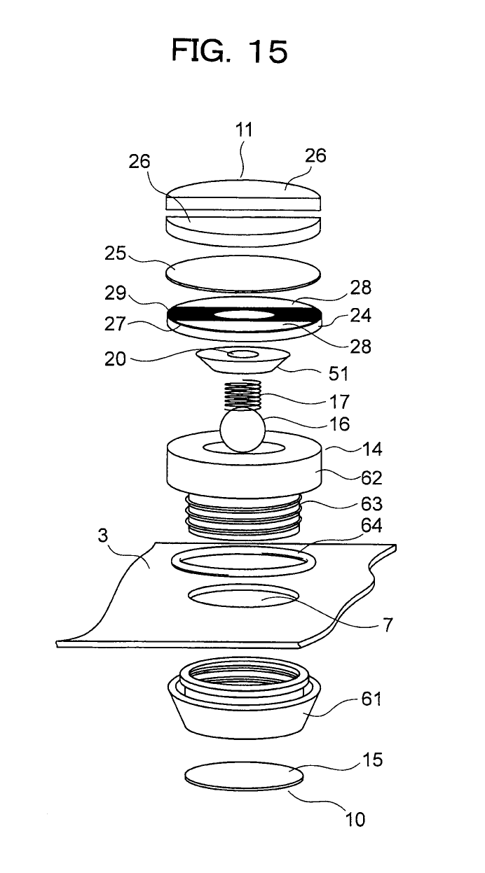

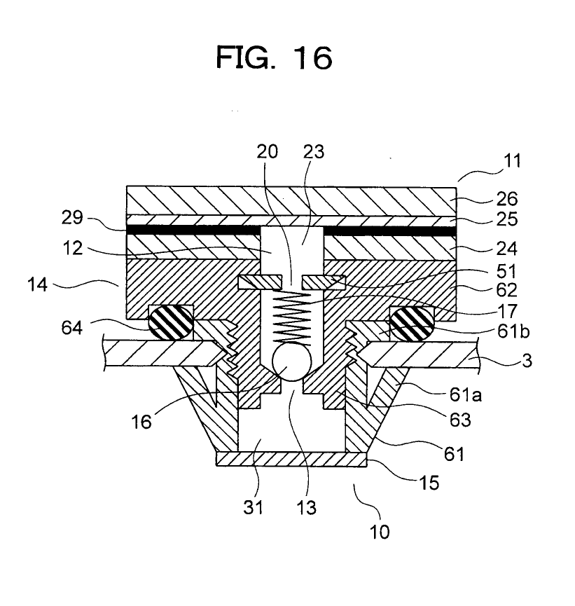

FIG. 14 is a perspective view illustrating an electric storage device according to a fifth embodiment of the present invention. FIG. 15 is an exploded perspective view illustrating a pressure regulator of FIG. 14. FIG. 16 is a sectional view taken along the line XVI-XVI of FIG. 14.

In the figures, the first gas release mechanism portion 10 is a self-restorable check valve device which maintains the function of blocking entry of gases to the inside space 8 even after the release of gases from the inside space 8 to the buffer space 12. The second gas release mechanism portion 11 is a self-restorable check valve device which maintains the function of blocking entry of gases to the buffer space 12 even after the release of gases from the buffer space 12 to the outside space 9.

The first gas release mechanism portion 10 includes the housing 14 which is provided with the valve housing vent hole 13, a part of which is inserted into the vent opening 7 from the outside of the sheath 3, a packing (hermetically sealing member) 61 provided between the sheath 3 and the housing 14, the gas-liquid separation film 15 provided inside the sheath 3 for covering the valve housing vent hole 13, the ball-like gas release valve 16 which is provided in the housing 14 and which may open and close the valve housing vent hole 13, the pressing member 17 provided in the housing 14 for urging the gas release valve 16 in the direction of closing the valve housing vent hole 13, and the detachment prevention lid 51 provided in the housing 14 for holding the pressing member 17 in the housing 14. Therefore, a part of the first gas release mechanism portion 10 is provided inside the sheath 3 and the rest is provided outside the sheath 3.

As the material of the packing 61, for example, a resin or a rubber is used. The packing 61 includes a cylindrical portion, a seal lip portion 61a which protrudes to the outside from one end of the cylindrical portion so as to form an acute angle, and an engaging portion 61b which protrudes perpendicularly to the outside from the other end of the cylindrical portion. The packing 61 is fit into the vent opening 7 with the sheath 3 being sandwiched between the seal lip portion 61a and the engaging portion 61b. Under a state in which the packing 61 is fit into the vent opening 7, the seal lip portion 61a is in contact with the inner surface of the sheath 3 and the electrolyte solution is prevented from flowing out.

The housing 14 includes a housing body 62 disposed outside the sheath 3 and a cylindrical protrusion 63 for attachment which protrudes from the housing body 62 and which is inserted into the vent opening 7 with the packing 61 therebetween. The valve housing vent hole 13 is provided in the protrusion 63 for attachment. A male thread portion is provided on the rim of the protrusion 63 for attachment. The male thread portion is screwed into a female thread portion provided in the inner periphery of the vent opening 7 with the packing 61 therebetween.

The housing 14 is attached to the sheath 3 by screwing the protrusion 63 for attachment into the packing 61 which is fit into the vent opening 7. The packing 61 hermetically seals a gap between the sheath 3 and the housing 14 by filling the gap between the sheath 3 and the housing 14 through elastic deformation by the male thread portion on the protrusion 63 for attachment and the female thread portion in the vent opening 7. Further, an O ring (sealing member) 64 for hermetically sealing a gap between the outer surface of the sheath 3 and the housing body 62 is provided between the outer surface of the sheath 3 and the housing body 62. In other words, the gap between the sheath 3 and the housing 14 is double sealed by the packing 61 and the O ring 64. This blocks leakage of the electrolyte solution and gases in the inside space 8 from the gap between the sheath 3 and the housing 14.

Here, the material of the housing 14 is similar to the material of the housing 14 of the first embodiment, and a plastic material, a metal material, or the like is used. The material of the sheath 3 is a material which is not broken even the internal pressure rises to 100 kPa or higher and may maintain the shape thereof on its own. As the material of the sheath 3, for example, a metal material such as a stainless steel or aluminum or a plastic material is used.

Only the rim of the gas-liquid separation film 15 is bonded to the packing 61 by heat-sealing. The gas-liquid separation film 15 except for the rim thereof is disposed away from the housing 14. This forms the in-valve space 31 between the gas-liquid separation film 15 except for the rim thereof and the protrusion 63 for attachment of the housing 14. Further, even when the pressure in the inside space 8 rises and the electrolyte solution passes through the gas-liquid separation film 15, by the electrolyte solution stored in the in-valve space 31, the gas passageway in the gas-liquid separation film 15 is secured to suppress deterioration of the gas transmission characteristics of the gas-liquid separation film 15. As the gas-liquid separation film 15, a film similar to the gas-liquid separation film 15 of the first embodiment is used.

The detachment prevention lid 51 is held in a space inside the housing body 62 with the rim thereof being fit into a depression provided in an inner surface of the housing body 62. The space inside the housing 14 is partitioned by the detachment prevention lid 51. The detachment prevention lid 51 is provided with the opening 20 for communication between two spaces in the housing 14 partitioned by the detachment prevention lid 51. As the material of the detachment prevention lid 51, a material similar to the material of the housing lid 18 of the first embodiment is used. In this example, the material of the detachment prevention lid 51 is a hard rubber.

The pressing member (compression spring) 17 is disposed in a state of being compressed between the detachment prevention lid 51 and the gas release valve 16. This causes the pressing member 17 to press the gas release valve 16 in the direction of closing the valve housing vent hole 13 in the housing 14 in a state of being pressed by the detachment prevention lid 51. In this example, the pressing member 17 is a spring. As the material of the gas release valve 16, a rubber or the like is used.

The structure of the second gas release mechanism portion 11 is similar to the structure of the second gas release mechanism portion 11 of the first embodiment. The housing 24 of the second gas release mechanism portion 11 is attached to the housing body 62. Further, the second gas release mechanism portion 11 is attached to the housing body 62 from the outside of the sheath 3 so as to cover the valve housing vent hole 13. In other words, the second gas release mechanism portion 11 is attached to a portion of the first gas release mechanism portion 10 provided outside the sheath 3 so as to cover the valve housing vent hole 13. The buffer space 12 includes the space in the opening 23 of the housing 24, the space in the housing body 62, and a space in the protrusion 63 for attachment.

Note that, in the second and third embodiments, the spacer 32 is provided between the gas-liquid separation film 15 and the housing 14, but, as long as the gas transmission characteristics of the gas-liquid separation film 15 may be maintained as in the first embodiment, the spacer 32 may be eliminated.

Further, in the first embodiment, the gas-liquid separation film 15 is directly bonded to the housing 14, but a spacer may be provided between the gas-liquid separation film 15 and the housing 14 of the first embodiment to form an in-valve space between the gas-liquid separation film 15 and the housing 14.

The structure of the first gas release mechanism portion 10 is not limited to the structures of the first to fifth embodiments as long as the structure is a structure of a gas release mechanism portion having the non-return function. Further, the structure of the second gas release mechanism portion 11 of the first, third, and fifth embodiments is not limited to the structures of the first, third, and fifth embodiments as long as the structure is a structure of a gas release mechanism portion having the non-return function. Further, the structure of the second gas release mechanism portion 11 of the second and fourth embodiments is not limited to the structures of the second and fourth embodiments as long as the structure is a structure of a non-self-restorable burst valve device which loses the function of blocking entry of gases once gases are released therethrough.

Further, the pressure regulator 4 of the third embodiment is a pressure regulator having a three-fold structure of the first gas release mechanism portion 10, the second gas release mechanism portion 11, and the third gas release mechanism portion 42, but it may be a pressure regulator having a four-or-more-fold structure of a plurality of gas release mechanism portions.

Further, in the first to third embodiments, the vent opening 7 provided in the sheath 3 is covered with the second gas release mechanism portion 11 from the outside of the sheath 3, but, insofar as the pressure regulator 4 has a two-or-more fold structure of a plurality of gas release mechanism portions, the vent opening 7 may be exposed to the outside space 9 of the sheath 3.

In the following, Examples 1 to 5 corresponding to the first to fifth embodiments, respectively, and Comparative Example 1 for comparison with Examples 1 to 5 are described. Note that, the electric storage devices in Examples 1 to 5 and Comparative Example 1 are electric double-layer capacitors.

### Example 1

In the electric storage device 1 of Example 1 corresponding to the first embodiment, the sheath 3 was formed with a PP resin being used as the material of the inside layer and with an aluminum laminate film using nylon being used as the material of the outside layer.

In the first gas release mechanism portion 10 of Example 1, an ethylene propylene rubber was used as the material of the gas release valve 16, a coil spring steel was used as the compression spring 17, a PP resin was used as the material of the housing lid 18, a PP resin was used as the material of the housing body 19, and methyl phenyl silicone oil was used as the liquid sealing material 22. Further, the kinematic viscosity of methyl phenyl silicone oil used as the sealing material 22 was 50 mm²/s.

In the first gas release mechanism portion 10 of Example 1, the valve housing vent holes 13 were designed to open when the difference between the pressure in the buffer space 12 and the pressure in the inside space 8 became 20 kPa. As the gas-liquid separation film 15, a PTFE porous film having an average pore diameter of 0.2 μm was used. This caused the pressure of the electrolyte solution when passing through the gas-liquid separation film 15 to be 100 kPa.

In the second gas release mechanism portion 11 of Example 1, a PET resin was used as the material of the housing 24, a PET film was used as the gas release valve 25, a PET resin was used as the material of the reinforcing members 26, and methyl phenyl silicone oil was used as the liquid sealing material 29. Further, the kinematic viscosity of methyl phenyl silicone oil used as the sealing material 29 was 1,000 mm²/s. Further, the second gas release mechanism portion 11 of Example 1 was designed to be activated when the pressure in the buffer space 12 became higher than the pressure in the outside space 9 by 5 kPa.

The electric storage device body 2 was manufactured by rolling the separator formed of cellulose and electrodes formed by applying activated carbon on aluminum current collector foil into a flat shape. With the electric storage device body 2 being impregnated with the electrolyte solution prepared by dissolving a quaternary ammonium salt in propylene carbonate, the electric storage device body 2 was encapsulated in and hermetically sealed by the sheath 3 to manufacture the electric storage device 1 of Example 1.

### Example 2

In the first gas release mechanism portion 10 of Example 2 corresponding to the second embodiment, a PET film was used as the gas release valve 16, a PP resin was used as the material of the pressing member 17, a PP resin was used as the material of the housing 14, and methyl phenyl silicone oil was used as the liquid sealing material 22. The kinematic viscosity of methyl phenyl silicone oil used as the sealing material 22 was 1,000 mm²/s.

In the first gas release mechanism portion 10 of Example 2, the valve housing vent holes 13 were designed to open when the difference between the pressure in the buffer space 12 and the pressure in the inside space 8 became 10 kPa. As the gas-liquid separation film 15, a PTFE porous film having an average pore diameter of 0.1 μm was used. This caused the pressure of the electrolyte solution when passing through the gas-liquid separation film 15 to be 150 kPa.

In the second gas release mechanism portion 11 of Example 2, disk-like aluminum foil was used as the gas release valve 25 and a PET resin was used as the material of the reinforcing members 26. Further, the second gas release mechanism portion 11 of Example 2 was designed to be activated when the pressure in the buffer space 12 became higher than the pressure in the outside space 9 by 20 kPa. Other points of the structure were similar to those of Example 1.

### Example 3

In the third gas release mechanism portion 42 of Example 3 corresponding to the third embodiment, a film in which a PP resin and a PE resin were blended was used as the gas release valve 45. Further, the third gas release mechanism portion 42 was formed by joining the inside layer formed of a PP resin of the sheath 3 and the gas release valve 45 by heat-sealing. Further, in the third gas release mechanism portion 42 of Example 3, the gas release valve 45 was designed to peel off the inner surface of the sheath 3 to open when the difference between the pressure in the inside space 8 and the pressure in the buffer space 43 became 10 kPa.

In the first gas release mechanism portion 10 of Example 3, an SUS (stainless steel) plate was used as the gas release valve 16. Further, in the first gas release mechanism portion 10 of Example 3, the valve housing vent hole 13 was designed to open when the difference between the pressure in the buffer space 12 and the pressure in the inside space 8 became 30 kPa. Other points of the structure of the first gas release mechanism portion 10 of Example 3 were similar to those of the structure of the first gas release mechanism portion 10 of Example 1.

The second gas release mechanism portion 11 of Example 3 was designed to be activated when the pressure in the buffer space 12 became higher than the pressure in the outside space 9 by 10 kPa. Other points of the structure of the second gas release mechanism portion 11 of Example 3 were similar to those of the structure of the second gas release mechanism portion 11 of Example 1. Other structures were similar to those of Example 1.

### Example 4

In the first gas release mechanism portion 10 of Example 4 corresponding to the fourth embodiment, a fluoro rubber plate was used as the material of the gas release valve 16. A coil spring steel was used as the pressing member 17, a PP resin was used as the material of the detachment prevention lid 51, a PP resin was used as the material of the housing 14, and methyl phenyl silicone oil was used as the liquid sealing material 22. The kinematic viscosity of methyl phenyl silicone oil used as the sealing material 22 was 3,000 mm²/s.

In the first gas release mechanism portion 10 of Example 4, the valve housing vent holes 13 were designed to open when the difference between the pressure in the buffer space 12 and the pressure in the inside space 8 became 50 kPa. As the gas-liquid separation film 15, a PTFE porous film having an average pore diameter of 0.1 μm was used, and the gas-liquid separation film 15 and the housing 14 were joined to each other by heat-sealing using an impulse welder. A fluoro rubber was used as the O ring 54. The housing 14 was fixed to the sheath 3 by screwing the male thread portion provided on the rim of the protrusion 53 for attachment into the female thread portion provided in the inner periphery of the vent opening 7.

A stainless steel container was used as the sheath 3 of Example 4, and stainless steel foil was used as the gas release valve 25 of the second gas release mechanism portion 11. The gas release valve 25 was joined to the sheath 3 by welding. The gas release valve 25 which was a burst valve was designed to burst at the thinly processed thin-walled portion 25a when the pressure in the buffer space 12 became higher than the pressure in the outside space 9 by 200 kPa.

The electric storage device body 2 was manufactured by rolling the separator formed of cellulose and electrodes formed by applying activated carbon on aluminum current collector foil into a flat shape. With the electric storage device body 2 being impregnated with the electrolyte solution prepared by dissolving a quaternary ammonium salt in propylene carbonate, the electric storage device body 2 was encapsulated in and hermetically sealed by the sheath 3 to manufacture the electric storage device 1 of Example 4.

### Example 5

In the first gas release mechanism portion 10 of Example 5 corresponding to the fifth embodiment, a fluoro rubber ball was used as the material of the gas release valve 16. A coil spring steel was used as the pressing member 17, a PP resin was used as the material of the detachment prevention lid 51, a stainless steel was used as the material of the housing 14, and a PTFE resin was used as the material of the packing 61.

In the first gas release mechanism portion 10 of Example 5, the valve housing vent holes 13 were designed to open when the difference between the pressure in the buffer space 12 and the pressure in the inside space 8 became 20 kPa. As the gas-liquid separation film 15, a PTFE porous film having an average pore diameter of 0.1 μm was used, and the gas-liquid separation film 15 and the packing 61 were joined to each other by heat-sealing using an impulse welder. A butyl rubber was used as the material of the O ring 64. The housing 14 was fixed to the sheath 3 by screwing the male thread portion provided on the rim of the protrusion 63 for attachment into the female thread portion of the opening 7 with the packing 61 therebetween. Here, the packing 61 was elastically deformed between the sheath 3 and the protrusion 63 for attachment to secure the airtightness in the sheath 3.

In the second gas release mechanism portion 11 of Example 5, a PET resin was used as the material of the housing 24, an aluminum laminate film was used as the gas release valve 25, a PET resin was used as the material of the reinforcing members 26, and methyl phenyl silicone oil was used as the liquid sealing material 29. The kinematic viscosity of methyl phenyl silicone oil used as the sealing material 29 was 3,000 mm²/s. Further, the second gas release mechanism portion 11 of Example 5 was designed to be activated when the pressure in the buffer space 12 became higher than the pressure in the outside space 9 by 10 kPa. Other points of the structure were similar to those of Example 4.

### Comparative Example 1

As Comparative Example 1, the electric storage device 1 of Example 2 in which the pressure regulator 4 included only the first gas release mechanism portion 10 was used.

In the electric storage device of Comparative Example 1, the sheath 3 was formed with a PP resin being used as the material of the inside layer and with an aluminum laminate film using nylon being used as the material of the outside layer.

In the first gas release mechanism portion 10 of Comparative Example 1, a PP resin was used as the material of the housing 14, a PET film was used as the gas release valve 16, a PP resin was used as the material of the pressing member 17, and silicone oil was used as the liquid sealing material 22. Further, the kinematic viscosity of silicone oil used as the sealing material 22 was 1 mm²/s.

Further, in the first gas release mechanism portion 10 of Comparative Example 1, the valve housing vent holes 13 were designed to open when the difference between the pressure in the buffer space 12 and the pressure in the inside space 8 became 5 kPa. As the gas-liquid separation film 15 of Comparative Example 1, a PTFE porous film having an average pore diameter of 0.1 μm was used. This causes the pressure of the electrolyte solution when passing through the gas-liquid separation film 15 to be 150 kPa.

The electric storage device body 2 of Comparative Example 1 was manufactured by rolling the separator formed of cellulose and electrodes formed by applying activated carbon on aluminum current collector foil into a flat shape. With the electric storage device body 2 being impregnated with 100 g of the electrolyte solution prepared by dissolving a quaternary ammonium salt in propylene carbonate, the electric storage device body 2 was encapsulated in and hermetically sealed by the sheath 3 to manufacture the electric storage device of Comparative Example 1.

Next, after the electric storage devices (electric double-layer capacitors) of Examples 1 to 5 and Comparative Example 1 in a 0 V discharge state were left under an environment at a temperature of 85° C. and at a relative humidity of 85% RH (experimental environment) for 1,000 hours, the amount of moisture mixed in the electrolyte solution was measured with regard to the electric storage devices of Examples 1 to 5 and Comparative Example 1. Further, after the electric storage devices (electric double-layer capacitors) of Examples 1 to 5 and Comparative Example 1 in a 2 V charge state were left under the environment at a temperature of 85° C. and at a relative humidity of 85% RH (experimental environment) for 1,000 hours, the amount of moisture mixed in the electrolyte solution was measured with regard to the electric storage devices of Examples 1 to 5 and Comparative Example 1.

The concentration of moisture in the electrolyte solution was measured using a Karl Fischer moisture titrator (MKA-520 manufactured by Kyoto Electronics Manufacturing Co., Ltd.) and, based on the measured concentration of moisture and the weight of the electrolyte solution, the amount of moisture mixed in the electrolyte solution was calculated. The amount of moisture mixed in the electrolyte solution before the experiment was 16 ppm.

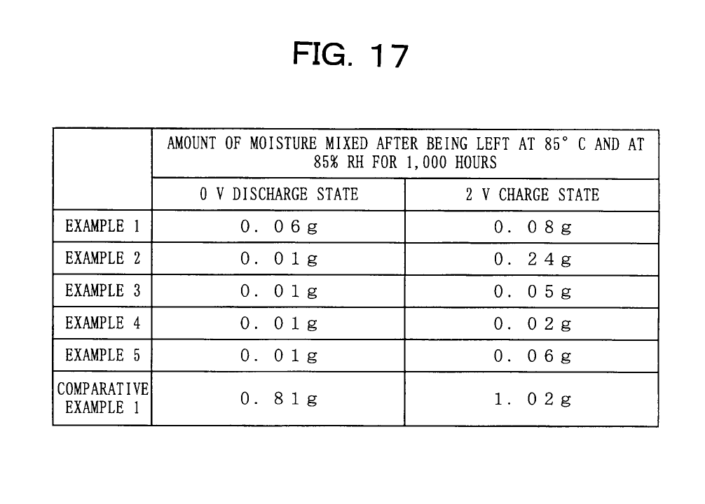

FIG. 17 is a comparative table among Examples 1 to 5 and Comparative Example 1 on the amount of moisture mixed in an electrolyte solution when the electric storage devices in a 0 V discharge state were left under an environment at a temperature of 85° C. and at a relative humidity of 85% RH (experimental environment) for 1,000 hours and when the electric storage devices in a 2 V charge state were left under the same experimental environment for 1,000 hours. As illustrated in FIG. 17, it can be seen that the amount of moisture mixed in the electrolyte solution was smaller in the electric storage devices of Examples 1 to 5 than in the electric storage device of Comparative Example 1. More specifically, it can be seen that, in the electric storage devices of Examples 1 to 5, the mixture of moisture in the electrolyte solution was suppressed compared with the case of the electric storage device of Comparative Example 1. From this, it was confirmed that, in the electric storage devices of Examples 1 to 5, the function deterioration of the pressure regulator 4 was suppressed for a longer time compared with the case of the electric storage device of Comparative Example 1.

What is claimed is:

1. An electric storage device, comprising:
an electric storage device body impregnated with an electrolyte solution;
a sheath for hermetically sealing the electric storage device body; and
a pressure regulator including a first gas release mechanism portion provided inside the sheath and a second gas release mechanism portion provided outside the sheath, the pressure regulator allowing release of gases from an inside space of the sheath in which the electric storage device body exists to an outside space by causing the gases from the inside space to pass through the first gas release mechanism portion and the second gas release mechanism portion in succession, and blocking entry of gases from the outside space to the inside space by the first gas release mechanism portion and the second gas release mechanism portion,
wherein a buffer space is formed between the first gas release mechanism portion and the second gas release mechanism portion by being partitioned by the first gas release mechanism portion and the second gas release mechanism portion.

2. An electric storage device according to claim 1, wherein:
a part of the first gas release mechanism portion is provided inside the sheath and the rest is provided outside the sheath; and
the second gas release mechanism portion is attached to the portion of the first gas release mechanism portion provided outside the sheath.

3. An electric storage device according to claim 1, wherein the first gas release mechanism portion comprises a gas-liquid separation film which faces the inside space in which the electric storage device body exists.

4. An electric storage device according to claim 2, wherein the first gas release mechanism portion comprises a gas-liquid separation film which faces the inside space in which the electric storage device body exists.

5. An electric storage device according to claim 1, wherein:
the first gas release mechanism portion comprises a gas release valve using a material which is resistant to the electrolyte solution; and
the second gas release mechanism portion comprises a gas release valve using a material which is resistant to water.

6. An electric storage device according to claim 2, wherein:
the first gas release mechanism portion comprises a gas release valve using a material which is resistant to the electrolyte solution; and
the second gas release mechanism portion comprises a gas release valve using a material which is resistant to water.

7. An electric storage device according to any one of claim 1, wherein one of the first gas release mechanism portion and the second gas release mechanism portion of the pressure regulator loses a function of blocking entry of gases to the inside space after passing of gases in a release direction to the outside space and another one of the first gas release mechanism portion and the second gas release mechanism portion maintains the function of blocking entry of gases to the inside space even after passing of gases in the release direction to the outside space.

8. An electric storage device according to any one of claim 2, wherein one of the first gas release mechanism portion and the second gas release mechanism portion of the pressure regulator loses a function of blocking entry of gases to the inside space after passing of gases in a release direction to the outside space and another one of the first gas release mechanism portion and the second gas release mechanism portion maintains the function of blocking entry of gases to the inside space even after passing of gases in the release direction to the outside space.

9. An electric storage device according to any one of claim 3, wherein one of the first gas release mechanism portion and the second gas release mechanism portion of the pressure regulator loses a function of blocking entry of gases to the inside space after passing of gases in a release direction to the outside space and another one of the first gas release mechanism portion and the second gas release mechanism portion maintains the function of blocking entry of gases to the inside space even after passing of gases in the release direction to the outside space.

10. An electric storage device according to any one of claim 4, wherein one of the first gas release mechanism portion and the second gas release mechanism portion of the pressure regulator loses a function of blocking entry of gases to the inside space after passing of gases in a release direction to the outside space and another one of the first gas release mechanism portion and the second gas release mechanism portion maintains the function of blocking entry of gases to the inside space even after passing of gases in the release direction to the outside space.
